(19) United States
(12) Patent Application Publication
(10) Pub. No.: US 2004/0071996 A1
(43) Pub. Date: Apr. 15, 2004

(54) Radio frequency weldable polyolefin film and process for production

(76) Inventor: John Michael Morrow, Burlington (CA)

Correspondence Address: Mark B. Eisen, Dimock Stratton Clarizio LLP, 20 Queen Street West, Suite 3202, Box 102, Toronto, ON, M5H 3R3, CA

(21) Appl. No.: 10/270,293

(22) Filed: Oct. 15, 2002

(51) Int. Cl. B32B 27/00

(52) U.S. Cl. 428/500; 428/523

(57) ABSTRACT

The present invention provides inexpensive polyolefin films with a built in adhesive for covering stationary products wherein the polyolefin films can be welded through the adhesive using radio frequency resulting in a stationery product that provides improved hinge durability, low temperature crack resistance and the elimination of image transfer. Also provided are methods of manufacture of the films and a method for the welding of the films around a rigid support material such as chipboard using a radio frequency signal.

### FIELD OF THE INVENTION

The invention relates generally to the field of covers for stationary products and in particular to radio frequency welding of polyolefin coatings for stationary products.

### BACKGROUND OF THE INVENTION

It is known in the art that stationary products such as ring binders, carry cases and file boxes which have pasted chipboard as a core material may be covered with a plastic material in order to enhance the appearance of the final product. Vinyl has historically been used as a covering material for such stationary products. A core rigid material, such as pasted chipboard, is used as structural support in the manufacture of many stationary products. The cover then encapsulates the rigid material and may be bonded to the rigid material by application of a wet adhesive.

Vinyl or polyvinyl chloride (PVC) and polypropylenes have been used as a covering material for pasted chipboard. The seams of the covering material can be welded together using the process of radio frequency welding. The machinery for this radio frequency welding is widely used and therefore available in the manufacture of stationary products.

PVC suffers from several disadvantages. In cold environments, i.e. approximately +10F or lower, PVC becomes brittle resulting in cracking or splitting in the covering of the stationary products. In addition, in stationary products having a hinge, such as a ring binder, PVC has a tendency to rip or split at the hinge due to the limited durability of the PVC. Aesthetically, PVC also presents some problems when used for example in a binder containing printed material. Image transfer from the printed material to the PVC can occur as a result of the use of a plasticizer in the manufacture of the PVC. As a consequence of the image transfer, PVC is not suitable for use as or in the production of storage pages for collectors of bills, coins and stamps as the plasticizer will leach out over time and damage the stored item, in turn decreasing the item's value. Each of these problems results in PVC covered stationary products having a limited application and a life span shorter than is desired.

In addition, PVC has been banned from use with stationary products in several European countries. One concern with the use of PVC is the possibility that it may constitute a carcinogen. Environmentally, PVC has also generated some concern. PVC is an inert material that does not rapidly degrade. Accordingly disposal of used product results in the accumulation of PVC in landfill disposal sites. Burning of PVC waste does not present a viable solution since a product from that burning is the production of dioxins, a compound having severe impact on the environment, including contributing to acid rain.

Polyolefin is another material which has been used to cover such stationary products. However, polyolefin also suffers from some disadvantages. Polyolefin, like PVC has been used to encapsulate the rigid material of the stationary product. This requires specialized equipment for the construction of polyolefin covers. In addition, polyolefin bonded to rigid material using this wet adhesion process may be prone to unsightly surface wrinkling as the product is used. Polyolefin is also a softer and more costly cover material to use than PVC when used in like weights.

Accordingly, there is a need for a cost effective surface cover material for some rigid stationary products, which covering is resistant to cracking at cold temperatures, is durable and does not wrinkle, and does not cause image transfer, while still uses widely available equipment in the manufacture of the stationary products.

### SUMMARY OF THE INVENTION

It is now an object of the present invention to provide an inexpensive polyolefin film with a built in adhesive for covering stationary products wherein the polyolefin film can be welded through the adhesive using radio frequency resulting in a stationery product that provides improved hinge durability, low temperature crack resistance and the elimination of image transfer.

Accordingly, one aspect of the invention provides a film comprising of a thin gauge polyolefin layer having an ethyl vinyl acetate component and a hot melt adhesive layer having an ethyl vinyl acetate component, which film can be welded through the adhesive.

Another aspect of the invention provides a process of manufacture of a film comprising a thin gauge polyolefin layer having an ethyl vinyl acetate component and a hot melt adhesive layer having an ethyl vinyl acetate component, which film can be welded through the adhesive.

A further aspect of the invention provides a method for the welding of a thin gauge polyolefin layer having an ethyl vinyl acetate component and a hot melt adhesive layer having an ethyl vinyl acetate component around a rigid support material such as chipboard using a radio frequency signal.

### BRIEF DESCRIPTION OF THE DRAWINGS

In drawings which illustrate by way of example only a preferred embodiment of the invention,

FIG. 1 shows a cross-sectional schematic view of the application of adhesive to a polyolefin film that can be welded for application to a chipboard ring binder support according to one aspect of the invention.

FIG. 2 shows a cross-sectional schematic view of the radio frequency sealing or welding of a polyolefin film as applied to a chipboard ring binder support according to one aspect of the invention.

FIG. 3 shows a cross-sectional schematic view of the activation of adhesive in a polyolefin film as applied to a chipboard ring binder support according to one aspect of the invention.

### DETAILED DESCRIPTION OF THE INVENTION

In one aspect the invention provides an economical and environmentally friendly polyolefin film for covering stationary products, a method of manufacture of that film, and a method for bonding that polyolefin film to rigid material such as chipboard using heat and pressure and widely available radio frequency welding equipment and a method of welding through the adhesive.

Polyolefin provides several advantages over PVC. Specifically, polyolefin provides increased durability and therefore is less prone to cracking or tearing at the hinge of stationary products. In fact, polyolefin has more than 10 times the hinge strength of PVC. In addition, polyolefin can resist cracking at cold temperatures of at least −40° F. Finally, image transfer does not occur when polyolefin is used as the cover material since it does not require the presence of plasticizer. Accordingly, polyolefin can be used to archive bills, coins and stamps as there is no plasticizer to leach out and damage the stored item.

The polyolefin film of the present invention is made using an encapsulating material which allows the film to be radio frequency welded. An encapsulating medium that allows the mixture to become positively or negatively charged allows the polyolefin film made with it to be radio frequency welded. A preferred encapsulating material is ethyl vinyl acetate, though other materials such as ethyl methyl acetate (EMA) ethyl acetyl acetate (EAA) can also be used. The encapsulating material should be present in an amount of between 40-80% by weight. In a preferred embodiment the encapsulating material is ethyl vinyl acetate and is present in the film mixture in an amount of 60% by weight.

The film material includes both polypropylene and low-density polyethylene. Taken together these materials should be present in the final mixture in an amount of 18-35% by weight the proportion of the polyethylene will impact upon the seal time of the film using radio frequency welding. In a preferred embodiment polypropylene random co-polymer and low density polyethylene will be present by weight in the amount of 21.9% and 8.6% respectively.

The film material also includes a surface modifier (slip) material and filler. Filler components present in amounts up to 25% by weight and surface modifiers, i.e. slip agent (such as euricamide stearate) present in an amount not exceeding 10% by weight affect the effectiveness of the ethyl vinyl acetate and must be adjusted for load for example when running coloured films. The slip material is intended to allow the final film to slide across surfaces. Suitable slip materials include talc, urethamide, sands or silicone. Further, suitable materials for the filler include talc or calcium carbonate.

The film may optionally be coloured thereby requiring the addition of dyes or colouring agents such as white colour concentrate TL02, or titanium dioxide. The amount of colouring agent required will depend upon the desired result and the agent selected. For example, titanium dioxide if added, is typically present in from 5% to 15% by weight.

Accordingly a preferred embodiment of the invention the film can be generated using a formulation according to the following ratios by weight:

| | |
|---|---|
| Ethyl Vinyl Acetate | 60% |
| Polypropylene Random Co-Polymer | 21.9% |
| Low Density Polyethylene | 8.6% |
| Slip | 2.9% |
| Filler | 1.8% |
| Colour Concentrate (e.g. white TL02) | 4.8% |

Ethylene in addition to impacting upon the seal time of the film during radio frequency welding is also used to make the surface of the material harder and more scratch resistant. However, in order to achieve these desired results the ethylene must be manufactured in a batch on a calendar hotter than normal. The suitable temperature range for this step of the process is 350-400F since the crystallization of the ethylene molecules is desired. The cooler the material is extruded or calendared the softer it will become when it is wound regardless of how much ethylene is used.

Various commercially available ethylenes such as those available from Eastman can be used. Low density ethylene is preferred, but medium density ethylene can also be used. However, the use of different ethylenes may require the addition or variation in the amount or selection of other additives such as filler or slip to stabilize the behaviour of the ethylene in the formulation, or achieve the desired characteristics in the final film.

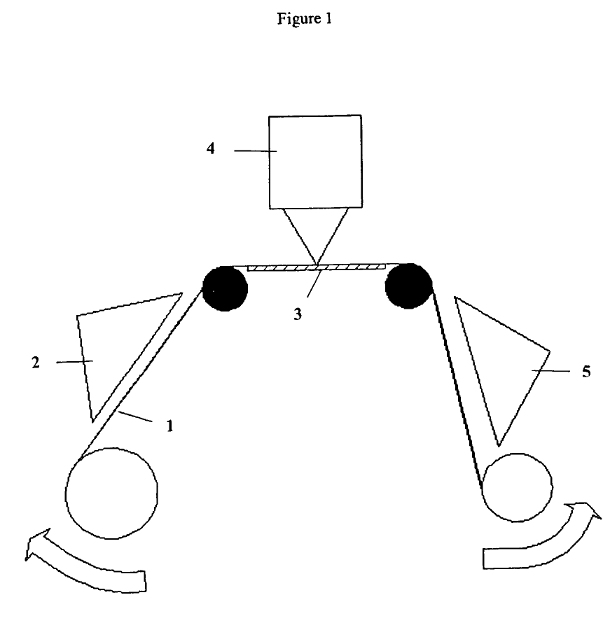

As illustrated in FIG. 1, the blended components are then extruded into a film 1 of the desired dimensions including thickness and width. The thickness of the film is typically from 4 millimetres to 7 millimetres. The widths can vary but are typically multiples of 12.5 inches wide.

The polyolefin film is then pre-chilled prior to coating with a hot melt adhesive or high molecular weight adhesive. The preferred adhesive is an ethyl vinyl acetate wax such as H. B. Fuller EVA wax. The wound film is unwound and passes through a pre-chill film blower 2 at a temperature in the range of 30-50° C., and preferably 40° C. The polyolefin film then passes across a chill plate 3 which is maintained at a temperature of from 30-50° C. to provide micro control of the film temperature as the hot adhesive is applied. The hot adhesive can be applied at from 170 F to 190 F but most preferably at about 180F using a slot coater 4. The temperature must be controlled to prevent the film temperature rising to a point where the film begins to flow. Control of temperature is important if the adhesive is applied using the extrusion method. This involves co-extruding the adhesive into position on the film when extruding the polyolefin. Other known methods of applying the adhesive can be used including spray, gravure, mitre rod or solution cast. The adhesive is applied ideally to a thickness of from about 0.003 to about 0.007 millimetres. This results in a polyolefin ethyl vinyl acetate film with a hot melt ethyl vinyl acetate adhesive back.

Once coated with the desired amount of adhesive, the film passes the path of a post coating film chiller 5 maintained at a temperature of from 40-60° C. before being wound onto a second spool. At this point the film can be converted to custom sized rolls or sheets depending upon the use to be made of the film. In addition to customizing the size of the rolls or sheets it is also possible at this stage to provide a custom imprint to the film by either screen printing or through a hot stamping process.

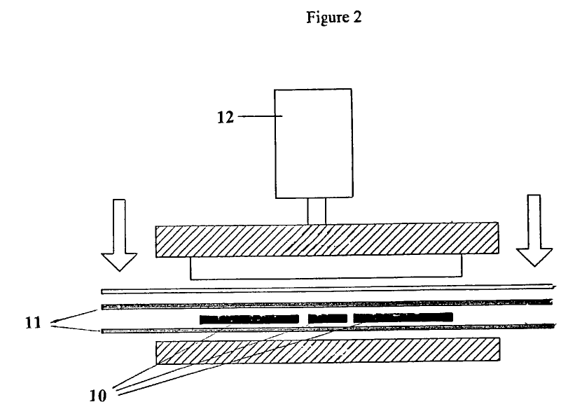

Once the film is created it is used to encapsulate pasted chipboard 10 to form the body of stationery products such as ring binders. Accordingly, the resulting polyolefin ethyl vinyl acetate film with a hot melt ethyl vinyl acetate adhesive back 11 being of the desired size and pattern can then be welded around the rigid support such as a pasted chipboard back, spine and front 10 as shown for example in FIG. 2 to make a binder flat. The polyolefin ethyl vinyl acetate film with a hot melt ethyl vinyl acetate adhesive back 11 can be sealed or welded around the chipboard supports 10 using radio frequency to seal the film and thereby to create the binder flat. The welding of the polyolefin ethyl vinyl acetate film with a hot melt ethyl vinyl acetate adhesive back is possible through the adhesive. Welding or sealing using a radio frequency signal is a common sealing method used for polyvinyl chloride and accordingly the equipment necessary for such radio frequency welding 12 is widely used in the stationary industry. Other methods of sealing which are currently in the marketplace can also be used with the film including ultrasonic, thermal or thermal impulse treatment.

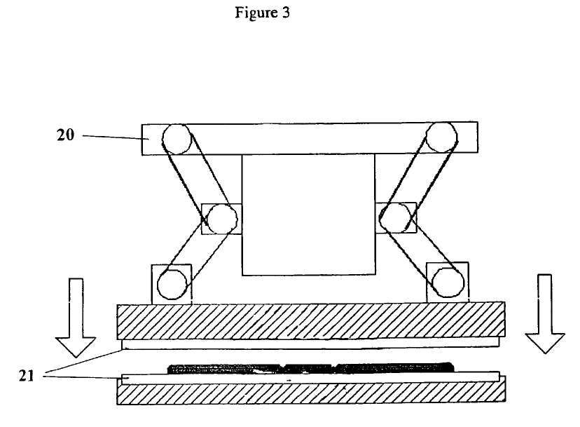

Once sealed using radio frequency welding or some other technique the hot melt ethyl vinyl acetate adhesive backing the polyolefin ethyl vinyl acetate film must be activated. Activation of the adhesive can be carried out using a combination of heat and pressure. The pressure and heat necessary for activation of the adhesive can be achieved using a toggle press 20 and ultra smooth chromium plates 21 as shown in FIG. 3. Suitable pressures range from 80-100 psi, at temperatures from about 125 to 155 F. The activation of the adhesive using heat and the applied pressure to the binder flat results in the polyolefin ethyl vinyl acetate film with a hot melt ethyl vinyl acetate adhesive back being bonded to the chipboard of the binder flat. It will be appreciated that a similar technique can be used to bond the film to other rigid support material of other stationary products.

Once welded and the adhesive has been activated to create a binder flat that is sealed on its perimeter and has a tight, smooth wrinkle free surface, other to the product can be added. This could include binder rings or labels to create product.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A film comprising a thin gauge polyolefin layer manufactured using an encapsulating material component and a hot melt adhesive layer manufactured using an encapsulating material component which film can be radio frequency welded through the adhesive.

2. The film of claim 1 wherein the encapsulating component is selected from ethyl methyl acetate, ethyl vinyl acetate and ethyl acetyl acetate.

3. The film of claim 1 wherein the encapsulating component is ethyl vinyl acetate.

4. The film of any one of claims 1 to 3 wherein the encapsulating component is present in an amount from 40%-80% by weight.

5. The film of any one of claims 1 to 3 wherein the encapsulating component is present in an amount of about 60% by weight.

6. The film of any one of claims 1 to 5 wherein the film includes polypropylene and an ethylene.

7. The film of claim 6 wherein the ethylene is low-density polyethylene.

8. The film of claim 7 wherein the film includes polypropylene and low-density polyethylene in a combined amount of from 18% to 35% by weight.

9. The film of claim 8 wherein the film includes polypropylene in the amount of about 22% by weight and low-density polyethylene in the amount of about 9% by weight.

10. The film of claim 1 wherein the film includes a surface modifier.

11. The film of claim 10 wherein the surface modifier is selected from the group comprising talc, urethamide, sands, silicone, and euricamide stearate.

12. The film of claim 1 wherein the film includes a filler.

13. The film of claim 12 wherein the filler is selected from the group comprising talc and calcium carbonate.

14. The film of claim 1 wherein the film includes a colorant.

15. The film of claim 1 wherein the thin gauge polyolefin layer is manufactured using by weight about 60% ethyl vinyl acetate, 21.9% polypropylene random co-polymer, 8.6% polyethylene, 2.9% slip agent, 1.8% filler, and 4.8% colour concentrate.

16. The film of any one of claims 1 or 15 wherein the hot melt adhesive is a high molecular weight adhesive.

17. The film of claim 16 wherein the high molecular weight adhesive is ethyl vinyl acetate wax.

18. The use of the film of any one of claims 1, 15 or 16 for covering stationary products.

19. A method of binding of stationary products having a rigid support with the film of any one of claims 1, 15 or 16 comprising the steps of:
covering the rigid support with the film;
sealing the film around the rigid support;
activating the holt melt adhesive; and
bonding the film to the rigid support material

20. The method of claim 19 wherein the step of sealing the film around the rigid support is achieved using a process selected from ultrasonic treatment, thermal treatment, thermal impulse treatment and radio frequency welding.

21. The method of claim 19 wherein the hot melt adhesive is activated using a combination of heat from 125 to 155F and pressure from 80 to 100 psi.

22. A method of manufacture of the film of any one of claims 1, 15 or 16 comprising the steps of:
blending the components of the thin gauge polyolefin layer;
extruding the polyolefin layer to the desired thickness and width;
pre-chilling the polyolefin layer;
coating the polyolefin layer with the hot melt adhesive; and
chilling the film after coating with the hot melt adhesive.

23. The method of claim 22 wherein the polyolefin layer is extruded to a thickness of from 4 to 7 millimetres.

24. The method of claim 22 wherein the polyolefin layer is pre-chilled at a temperature of from 300 to 50° C.

25. The method of claim 22 wherein the thin gauge polyolefin layer passes across a chill plate which is maintained at a temperature of from 30-50° C. during coating of the polyolefin layer with the hot melt adhesive.

26. The method of claim 22 wherein the hot melt adhesive is applied at a temperature of from 170 F to 190 F.

27. The method of claim 22 wherein the hot melt adhesive is applied using a slot coater.

28. The method of claim 27 wherein the hot melt adhesive is applied to a thickness of from 0.003 to 0.007 millimetres.

29. The method of claim 22 wherein chilling the film after coating with the hot melt adhesive is at a temperature of from 400 to 600C.
